(19) United States
(12) Patent Application Publication
(10) Pub. No.: US 2022/0414524 A1
(43) Pub. Date: Dec. 29, 2022

(54) Incident Paging System

(71) Applicant: Capital One Services, LLC, McLean, VA (US)

(72) Inventors: Matthew Louis Nowak, Midlothian, VA (US); Thomas A. Withers, Chester, VA (US); Michael Anthony Young, JR., Henrico, VA (US)

(21) Appl. No.: 17/355,407

(22) Filed: Jun. 23, 2021

(51) Int. Cl. G06N 20/00; H04L 12/18

(52) U.S. Cl. CPC G06N 20/00; H04L 12/1881; G06F 40/20

(57) ABSTRACT

Aspects described herein may use machine learning models to predict individuals or teams to assign to a discussion group in response to the occurrence of a new incident of an entity. A first machine learning model recognizes relationships between data concerning previous incidents, including remediation actions and individuals assigned to a discussion group on the corresponding incident, and a new incident. A second machine learning model predicts individuals to assign to a discussion group to address the new incident and schedules a conference bridge based upon known scheduling data of the individuals.

### FIELD OF USE

Aspects of the disclosure relate generally to assigning one or more contacts to a conference call to mitigate the occurrence of a new incident of an entity. More specifically, aspects of the disclosure provide techniques for using a machine learning models to predict one or more individuals to assign to a conference call or discussion group to mitigate the new incident.

### BACKGROUND

Operational efficiency often is sought by entities. Many entities want their business to operate with as few incidents that require some form of mitigation to address. For example, cybersecurity is a sector of an entity's business that has increased substantially in recent years. Attacks from hackers and other nefarious individuals are a constant siege for an entity on a daily basis. Coupled with that are power outages, equipment failures, human errors, and other types of incidents that an entity must manage constantly. Yet when new incidents occur for an entity, conventional systems for mitigating the occurrence is slow and hampered by wasted time and resources.

FIG. 1 depicts an example of conventional manner in which a new incident at an entity is addressed. At step 101, a new incident occurs. For example, a fire at a facility that maintains operational backup data servers for an entity may occur. In response to the occurrence of the incident, some likely form of action occurs. In step 103, an incident manager receives notification of the new incident. The incident manager may be someone within the entity that is assigned to address new incidents when they are identified but also may not be someone that directly mitigates the occurrence of the new incident.

In step 105, the incident manager determines one or more individuals to conduct a conference call to discuss the new incident. In this case, the incident manager may want to contact a service matter expert on the operational backup data servers or facility manager for the facility where the fire occurred. In step 107, the incident manager logs into a computer system and sends one or more invitations to individuals the incident manager has contact information for to meet for the conference call. However, it is merely up to the incident manager to determine who to invite to a conference call for discussion purposes and whether that incident manager has contact information available for the individuals.

After the conference call has started, in step 109, an individual on the conference call may determine that she is not the right person to be on the conference call to mitigate the incident. For example, the facility manager for the facility where the fire occurred may inform individuals on the call or the incident manager that she is not the best person to handle or that another individual should be added to the conference call. Thereafter, the incident manager in step 111 sends invitations to one or more different and/or additional individuals to the conference call based upon guessing who might be the next person to try to contact.

Aspects described herein may address these and other problems, and generally enable predicting the proper individuals to assign to a conference call for mitigating an incident in a more reliable and robust manner. Such a prediction thereby reduces the likelihood that the wrong individuals or unavailable individuals are assigned to such a conference call and reduces the time and resources spent in mitigating the occurrence of the incident as quickly or efficiently as possible.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for the prediction and assignment of one or more contacts to a conference call or discussion group to mitigate the occurrence of a new incident of an entity that has occurred. This may have the effect of significantly improving the ability of entities to ensure expedited mitigation of an incident affecting the entity, ensure individuals likely to be suited for a discussion on mitigating the incident are identified and notified in an accelerated manner, automatically predict and even send invitations to such a discussion, and improve incident management experiences for future incidents. According to some aspects, these and other benefits may be achieved by taking previous incident data and identification of individuals that mitigated such incidents, compiling such data, and utilizing it with machine learning models trained to recognize relationships between such previous data and new incident data and paging scheduling data and to predict the individuals to assign to mitigate the new incident. Such a prediction then may be used to automatically schedule the assigned individuals to a conference call or discussion group to mitigate the new incident as quickly and/or efficiently as possible.

Aspects discussed herein may provide a computer-implemented method for determining individuals to assign to a new incident in order to facilitate initiating a conference call or discussion group on an expedited basis. For example, in at least one implementation, a computing device may receive, ownership data representative of assets, involved in one or more incidents, of an entity and data representative of associations between the assets. The computing device may receive previous incident data representative of the one or more incidents that was assigned at least one remediation action, where each remediation action was assigned to mitigate reoccurrence of a corresponding incident. The computing device also may receive previous paging data representative of one or more contacts that was identified for mitigating reoccurrence of a corresponding incident of the previous incident data. This data may be compiled, by the computing device and by utilizing natural language processing, as input data to a machine learning model data store. The same or a second computing device may receive new incident data, representative of a new incident involving one or more of the assets, and paging scheduling data, representative of availability of one or more contacts to meet to mitigate the new incident. The same or the first computing device may utilize a first machine learning model trained to recognize one or more relationships between the input data in the machine learning model data store to refine the data stored therein. The refinement data may be an update of the input data in the machine learning model data store based upon the new incident data and the paging scheduling data. A second machine learning model trained to recognize one or more relationships between the input data in the machine learning model data store, the new incident, and the paging scheduling data, may predict one or more contacts to assign to the new incident for a conference call or discussion group meeting. Then, based upon the predicted one or more contacts, contact data representative of the one or more contacts to assign to the new incident may be outputted and used to invite the one or more assigned contacts to a conference call.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of conventional manner in which a new incident at an entity is addressed;

FIG. 2 depicts an example of a computing environment that may be used in implementing one or more aspects of the disclosure in accordance with one or more illustrative aspects discussed herein;

FIG. 3 illustrates a system for assigning one or more contacts to a conference call to mitigate the occurrence of a new incident of an entity in accordance with one or more aspects described herein; and

FIGS. 4A-4B depict a flowchart for a method for assigning one or more contacts to a conference call to mitigate the occurrence of a new incident of an entity in accordance with one or more aspects described herein.

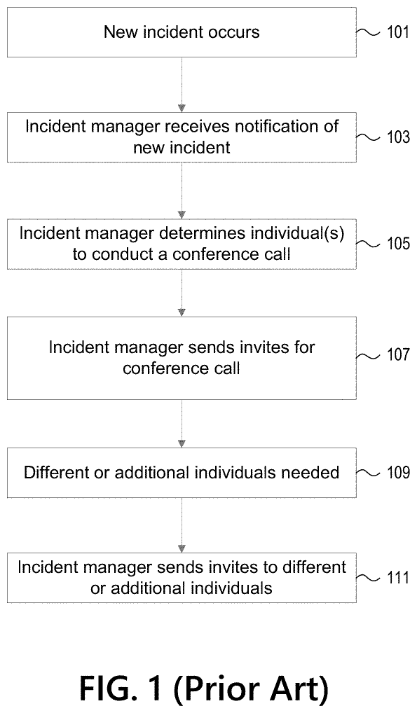

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for assigning one or more contacts to a conference call to mitigate the occurrence of a new incident of an entity. A new incident may occur for an entity. For example, an outage may occur at a facility that maintains servers that are accessible by customers as part of an application on a mobile device. Illustrative example applications includes applications for ordering groceries, for checking financial data, for uploading photos as part of a claim on a car accident, and/or other uses. Upon identification of the new incident occurring, the present disclosure describes receiving data on the new incident and receiving paging data representative of availability of one or more individuals who are available to discuss the procedures or protocols to mitigate the new incident. Ownership data representative of assets, involved in one or more previous incidents, of an entity and associations between the assets may be received. Data on the previous incidents, including data representative of assigned remediation actions also may be received. The remediation actions may be actions assigned to mitigate reoccurrence of a corresponding incident. Previous paging data, representative of one or more individuals that were identified for mitigating reoccurrence of a corresponding previous incident may be received.

Natural language processing may be used to compile the ownership data, the previous incident data, and the previous paging data as input data to a machine learning model data store. A first machine learning model may recognize one or more relationships between the input data in the machine learning model data store to refine the data in the data store. The refinement data may be used to update the input data in the machine learning model data store based upon the new incident data and paging scheduling data. A second machine learning model trained to recognize one or more relationships between the input data in the machine learning model data store, the new incident, and the paging scheduling data, may be used to predict one or more individuals to assign to a conference call or discussion group to mitigate the new incident. As part of the prediction, a score may be generated, based on the predicted one or more relationships, for each of the one or more individuals to assign to the new incident. Each score may be representative of a confidence level of the individual being an appropriate contact to assign to the new incident. Based upon the predicted contacts, contact data representative of the one or more contacts to assign to the new incident may be outputted and invites to a conference call or discussion group (e.g., a Slack channel, a group chat, a text message group, etc.) also may be sent to each contact. In addition, a severity level of the new incident may be predicted based on the recognized one or more relationships between the input data in the machine learning model data store, the new incident, and/or the paging scheduling data. In addition, a user input may be received that is representative of a confirmation of assigning, to the new incident, one or more of the contacts of the contact data.

Aspects described herein improve the functioning of computers by improving the ability of computing devices to identify the proper individuals to assign to a conference call for mitigating an incident. Conventional systems for assigning contacts to a conference call to mitigate the occurrence of an incident of an entity are susceptible to failure—for example, an assigned contact that is unavailable or improper to help mitigate the incident may lead to wasted time and resources to address the occurrence of the incident. As such, these conventional techniques leave entities exposed to the possibility of a prolonged effect of the incident on the operation of the entity. In turn, the improperly assigned individuals may be faced with significant burdens to drop everything for a conference call or discussion in which they are not equipped to address and then to revert back to other work or projects they were working. By providing improved assignment techniques—for example, based on predicting the likely contacts to assign, based upon previous incidents, previous assignments, paging scheduling data, and incident severity determinations, to mitigate an incident—a proper contact can be more accurately determined. Over time, the processes described herein can save processing time, network bandwidth, and other computing resources. Moreover, such improvement cannot be performed by a human being with the level of accuracy obtainable by computer-implemented techniques to ensure accurate prediction of the individuals.

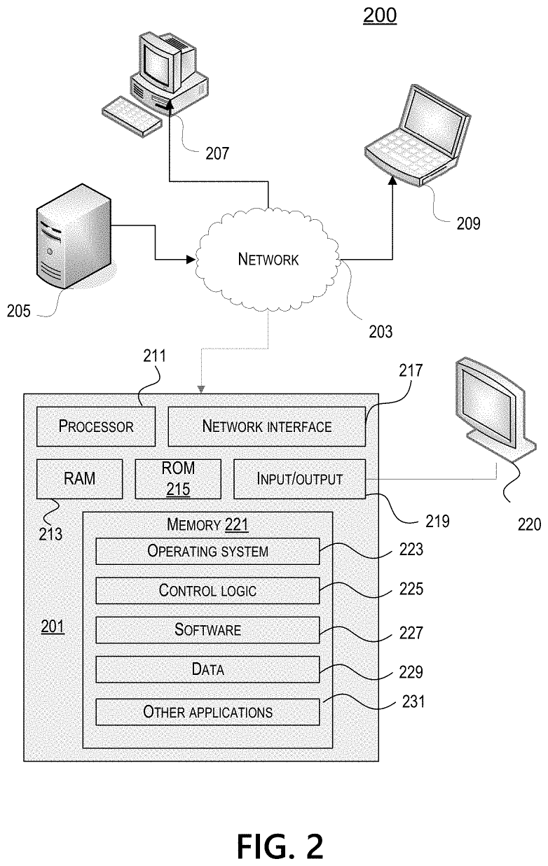

Before discussing these concepts in greater detail, however, several examples of a computing device and environment that may be used in implementing and/or otherwise providing various aspects of the disclosure will first be discussed with respect to FIG. 2.

FIG. 2 illustrates one example of a computing environment 200 and computing device 201 that may be used to implement one or more illustrative aspects discussed herein. For example, computing device 201 may, in some embodiments, implement one or more aspects of the disclosure by reading and/or executing instructions and performing one or more actions based on the instructions. In some embodiments, computing device 201 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 201 may, in some embodiments, operate in a standalone environment. In others, computing device 201 may operate in a networked environment, including network 381. As shown in FIG. 2, various network nodes 201, 205, 207, and 209 may be interconnected via a network 203, such as the Internet. Other networks may also or alternatively be used, including private intranets, corporate networks, local area networks (LANs), wireless networks, personal networks (PAN), and the like. Network 203 is for illustration purposes and may be replaced with fewer or additional computer networks. A LAN may have one or more of any known LAN topologies and may use one or more of a variety of different protocols, such as Ethernet. Devices 201, 205, 207, 209 and other devices (not shown) may be connected to one or more of the networks via twisted pair wires, coaxial cable, fiber optics, radio waves, or other communication media.

As seen in FIG. 2, computing device 201 may include a processor 211, RAM 213, ROM 215, network interface 217, input/output (I/O) interfaces 219 (e.g., keyboard, mouse, display, printer, etc.), and memory 221. Processor 211 may include one or more computer processing units (CPUs), graphical processing units (GPUs), and/or other processing units such as a processor adapted to perform computations associated with machine learning. Processor 211 may control an overall operation of the computing device 201 and its associated components, including RAM 213, ROM 215, network interface 217, I/O interfaces 219, and/or memory 221. Processor 211 can include a single central processing unit (CPU) (and/or graphic processing unit (GPU)), which can include a single-core or multi-core processor along with multiple processors. Processor(s) 211 and associated components can allow the computing device 201 to execute a series of computer-readable instructions to perform some or all of the processes described herein. A data bus can interconnect processor(s) 211, RAM 213, ROM 215, memory 221, I/O interfaces 219, and/or network interface 217.

I/O interfaces 219 may include a variety of interface units and drives for reading, writing, displaying, and/or printing data or files. I/O interfaces 219 may be coupled with a display such as display 220. I/O interfaces 219 can include a microphone, keypad, touch screen, and/or stylus through which a user of the computing device 201 can provide input, and can also include one or more of a speaker for providing audio output and a video display device for providing textual, audiovisual, and/or graphical output.

Network interface 217 can include one or more transceivers, digital signal processors, and/or additional circuitry and software for communicating via any network, wired or wireless, using any protocol as described herein. It will be appreciated that the network connections shown are illustrative and any means of establishing a communications link between the computers or other devices can be used. The existence of any of various network protocols such as TCP/IP, Ethernet, FTP, Hypertext Transfer Protocol (HTTP) and the like, and various wireless communication technologies such as Global system for Mobile Communication (GSM), Code-division multiple access (CDMA), WiFi, and Long-Term Evolution (LTE), is presumed, and the various computing devices described herein can be configured to communicate using any of these network protocols or technologies.

Memory 221 may store software for configuring computing device 201 into a special purpose computing device in order to perform one or more of the various functions discussed herein. Memory 221 may store operating system software 223 for controlling overall operation of computing device 201, control logic 225 for instructing computing device 201 to perform aspects discussed herein, software 227, data 229, and other applications 231. Control logic 225 may be incorporated in and may be a part of software 227. In other embodiments, computing device 201 may include two or more of any and/or all of these components (e.g., two or more processors, two or more memories, etc.) and/or other components and/or subsystems not illustrated here.

Devices 205, 207, 209 may have similar or different architecture as described with respect to computing device 201. Those of skill in the art will appreciate that the functionality of computing device 201 (or device 205, 207, 209) as described herein may be spread across multiple data processing devices, for example, to distribute processing load across multiple computers, to segregate transactions based on geographic location, user access level, quality of service (QoS), etc. For example, devices 201, 205, 207, 209, and others may operate in concert to provide parallel computing features in support of the operation of control logic 225 and/or software 227.

Although not shown in FIG. 2, various elements within memory 221 or other components in computing device 201, can include one or more caches including, but not limited to, CPU caches used by the processor 211, page caches used by an operating system, disk caches of a hard drive, and/or database caches used to cache content from a data store. For embodiments including a CPU cache, the CPU cache can be used by one or more processors 211 to reduce memory latency and access time. Processor 211 can retrieve data from or write data to the CPU cache rather than reading/writing to memory 221, which can improve the speed of these operations. In some examples, a database cache can be created in which certain data from a data store is cached in a separate smaller database in a memory separate from the data store, such as in RAM 215 or on a separate computing device. For instance, in a multi-tiered application, a database cache on an application server can reduce data retrieval and data manipulation time by not needing to communicate over a network with a back-end database server. These types of caches and others can be included in various embodiments, and can provide potential advantages in certain implementations of devices, systems, and methods described herein, such as faster response times and less dependence on network conditions when transmitting and receiving data.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

Although various components of computing device 201 are described separately, functionality of the various components can be combined and/or performed by a single component and/or multiple computing devices in communication without departing from the invention. Having discussed several examples of computing devices which may be used to implement some aspects as discussed further below, discussion will now turn to various examples for assigning one or more individual to a discussion group to mitigate the occurrence of a new incident of an entity.

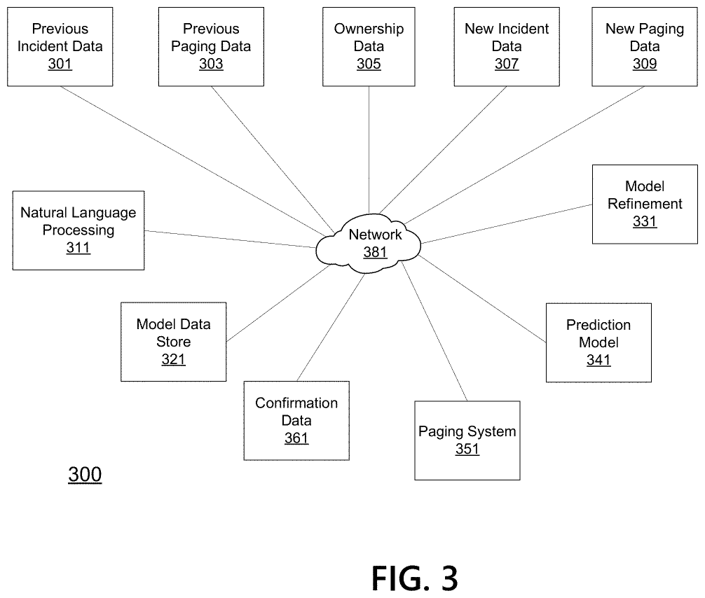

FIG. 3 illustrates a system 300 for assigning one or more contacts to a conference call to mitigate the occurrence of a new incident of an entity. The operating environment 300 may include computing devices 311, 331, and 341, memories or databases 301, 303, 305, 307, 309, 321, and 361, and a paging system 351 in communication via a network 381. Network 381 may be network 203 in FIG. 2. It will be appreciated that the network 381 connections shown are illustrative and any means of establishing a communications link between the computing devices, paging system, and memories or databases may be used. The existence of any of various network protocols such as Transmission Control Protocol/Internet Protocol (TCP/IP), Ethernet, FTP, HTTP and the like, and of various wireless communication technologies such as GSM, CDMA, WiFi, and LTE, is presumed, and the various computing devices described herein may be configured to communicate using any of these network protocols or technologies. Any of the devices and systems described herein may be implemented, in whole or in part, using one or more computing devices and/or network described with respect to FIG. 2.

As shown in FIG. 3, the system 300 may include one or more memories or databases that maintains previous incident data 301. A computing device utilizing natural language processing 311 may be configured to access the one or more memories or databases that maintains previous incident data 301. The previous incident data 301 may include data representative of one or more past incidents of the entity. The previous incident data 301 may be historical data of previous incidents, including causes of an incident, start time of an incident, end time of an incident, time periods of an incident, assets of the entity effected by an incident, locations where an incident occurred, a severity of an incident in effecting some operation or function of the entity, and/or data regarding successful steps taken and failures in mitigating an incident. The previous incident data 301 also may include one or more remediation actions that was assigned to mitigate reoccurrence of a corresponding past incident. The remediation action data also may include new protocols and/or procedures implemented in response to the corresponding incident and/or new equipment used in conjunction with or as a back up to, assets involved in the previous incident. Any specific action that may have been used to mitigate the reoccurrence of a previous incident is an example remediation action.

The system 300 may include one or more memories or databases that maintains previous paging data 303. A computing device utilizing natural language processing 311 may be configured to access the one or more memories or databases that maintains previous paging data 303. The previous paging data 303 may include data representative of one or more contacts that were identified for mitigating reoccurrence of a corresponding incident of the previous incident data. An entity may maintain historical data of previous paging data 303, such as names and/or contact information, for individuals that assisted in mitigating a previous incident. The previous paging data 303 may include other descriptions for the corresponding individuals, including title at the entity, role or position at the entity, and other information.

The system 300 may include one or more memories or databases that maintains ownership data 305. A computing device utilizing natural language processing 311 may be configured to access the one or more memories or databases that maintains ownership data 305. The ownership data 305 may include data representative of assets of an entity. Assets of an entity may include computing devices, databases, servers, facilities, and/or other equipment of the entity. The assets of the entity may have been involved in one or more incidents in which mitigation of the incident was needed. The ownership data 305 also may include data representative of associations between the assets of the entity.

System 300 may include one or more memories or databases that maintains new incident data 307. A computing device utilizing a machine learning model 331 for refining input data of a machine learning model data store may be configured to access the one or more memories or databases that maintains new incident data 307. The new incident data 307 may include data representative of a new incident involving one or more of the assets of the entity. The new incident data 307 may include data representative of an incident of the entity that has occurred where one or more individuals need to be assigned to a conference call or discussion group to mitigate the incident and prevent reoccurrence. Such new incident data 307 may include the impact of the incident on the entity, the specific operation or function of the entity effected, causes of the incident, times of the incident, assets effected, locations of the incident, and the severity of the incident in effecting some operation or function of the entity.

System 300 may include one or more memories or databases that maintains new paging scheduling data 309. A computing device utilizing a machine learning model 331 for refining input data of a machine learning model data store may be configured to access the one or more memories or databases that maintains new paging scheduling data 309. The new paging data 309 may include data representative of availability of one or more contacts to meet to mitigate the new incident. An entity may maintain paging scheduling data 309, including names and/or contact information, for individuals that may be identified to assist in mitigating new incidents that occur at the entity. The paging scheduling data 309 may include other descriptions for the corresponding individuals. In addition, the paging scheduling data 309 may include other individuals that work with that individual.

System 300 may include one or more computing devices utilizing natural language processing 311. The one or more computing devices utilizing natural language processing 311 may receive data and/or access data from one or more of memories or databases 301, 303, and 305. Natural language processing 311 may be utilized in order to account for textual and/or other data entries that do not consistently identify the same or similar data in the same way. The natural language processing 311 may be utilized to identify text in data of various types and in various formats. The identified text may be grouped with similarly identified text into various fields for inclusion in a machine learning model data store 321. The machine learning model data store 321 may be configured to maintain the various fields of data. The various fields of data including time series data, scoring data, previous prediction data, and/or user confirmation data as described herein below. The fields of data maintained in the machine learning model data store 321 may be used thereafter as input data to one or more machine learning models 331 and 341.

System 300 may include one or more computing devices implementing a first machine learning model 331. First machine learning model 331 may be trained to recognize one or more relationships between input data in the machine learning model data store 321. The first machine learning model 331 may be configured to refine model data that is stored in the machine learning model data store 321. The refinement data updates the input data in the machine learning model data store 321 based upon the new incident data 307 and paging scheduling data 309.

System 300 also may include one or more computing devices implementing a second machine learning model 341. Second machine learning model 341 may be trained to recognize one or more relationships between the input data in the machine learning model data store 321, the new incident data 307, and the paging scheduling data 309. The second machine learning model 341 may be configured to predict one or more contacts to assign to the new incident to mitigate the incident. The one or more contacts may be individuals in the paging scheduling data 309 that has been inputted and maintained in the machine learning model data store 321. The predicted contacts may be those individuals that the second machine learning model 331 has determined to be the individuals that should be on a conference call or part of a discussion group to mitigate the new incident based upon what it has learned from previous incidents and feedback data.

System 300 includes a paging system 351 configured to send an invitation, to each of the one or more contacts assigned to a new incident, to a conference call, discussion group, or other meeting to mitigate the new incident. Such an invitation may be sent as a call, a text message, an instant message, an email, or some other type of notification to an assigned contact to join a conference call. Thereafter, the assigned contacts may meet to discuss one or more remediation actions to take in response to the new incident.

System 300 also includes confirmation data 361. Confirmation data 361 may include receiving user input that is representative of a confirmation of assigning, to the new incident, one or more predicted contacts. System 300 may be configured to be completely automate where predicted contacts are automatically assigned. Alternatively, system 300 may be configured to require a confirmation by a user prior to assigning one or more of the predicted contacts to the new incident. The user may confirm all, some, or none of the contacts that the system has predicted. In some occurrences, the user may identify additional and/or different contacts to assign to the new incident. This user confirmation and/or user override of contact assignment may be feedback data to the machine learning model data store 321. Input data maintained in the machine learning model data store 321 and utilized by the machine learning models 331 and 341 described herein may be updated to account for the feedback data 361.

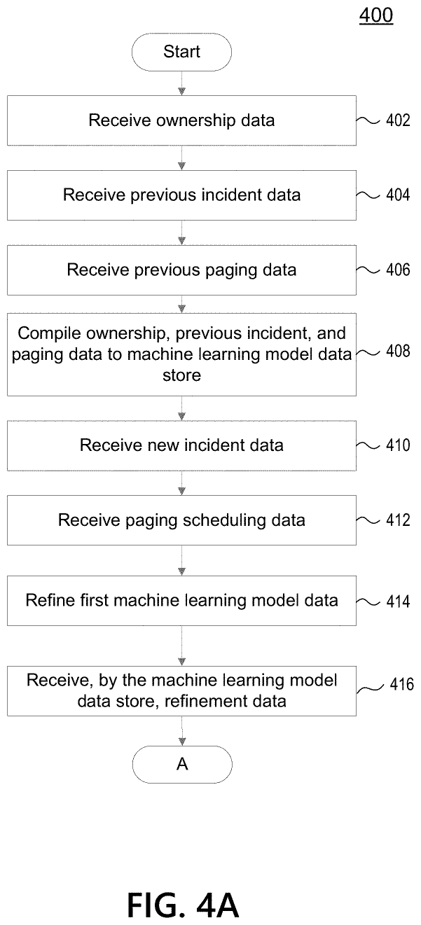

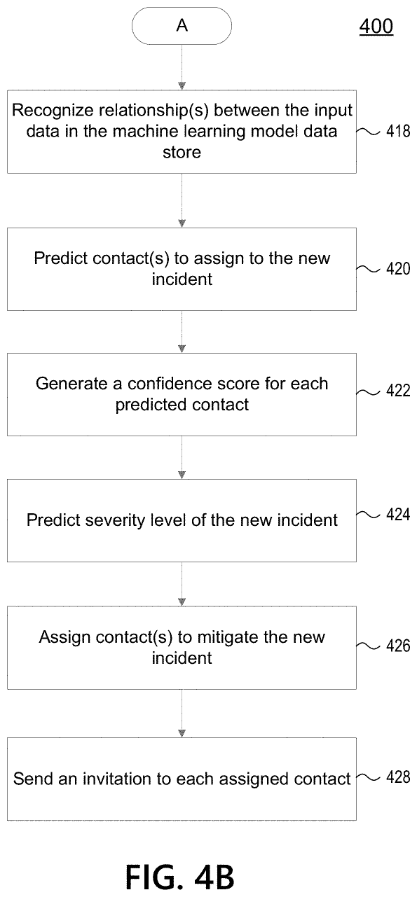

FIGS. 4A-4B depict a flow diagram of an example method 400 for assigning one or more contacts to a conference call to mitigate the occurrence of a new incident of an entity. Some or all of the steps of method 400 may be performed using a system that comprises one or more computing devices as described herein, including, for example, computing device 201, or computing devices in FIG. 2, and computing devices in FIG. 3.

At step 402, one or more computing devices may receive ownership data. Ownership data may be maintained in a memory of a computing device and/or as part of a database or other memory location accessible by a computing device. The ownership data may include data representative of assets of an entity. The assets of the entity may have been involved in one or more incidents in which mitigation of the incident was needed. Illustrative examples of an incident include the destruction of entity equipment, a cybersecurity attack on equipment of an entity, a power outage effecting equipment of an entity, and data corruption associated with equipment of an entity. The ownership data also may include data representative of associations between the assets of the entity. For example, two assets (e.g., pieces of equipment) may both be maintained within a certain building of the entity. Thus, a fire at the certain building may affect both assets. Two or more assets also may be associated with each other as they provide data to and/or receive data from the other assets. For example, an application on a mobile device may access a user authentication server to ensure a user has access rights to certain data and the application may separately access a database that maintains content desired by the user. Accordingly, there may be an association established between the application and the authentication server and between the application and the database and/or between the application, the authentication server, and the database.

At step 404, one or more computing devices may receive previous incident data. Previous incident data may be maintained in a memory of a computing device and/or as part of a database or other memory location accessible by a computing device. The previous incident data may include data representative of one or more past incidents of the entity. As such, an entity may maintain historical data of previous incidents, including causes, times, assets effected, locations, severity of the incident in effecting some operation or function of the entity, and/or successes and failures in mitigating the incidents. The previous incident data may include one or more remediation actions that was assigned to mitigate reoccurrence of a corresponding past incident. In the example of a previous incident in which a fire at a facility occurred, incident data, a remediation action may have been to place equipment in a fire retardant location and/or to implement a fire extinguishing system in a room housing such equipment. The remediation action data also may include new protocols and procedures implemented in response to the corresponding incident and/or new equipment used in conjunction with or as a back up to, assets involved in the previous incident. Any specific action that may have been used to mitigate the reoccurrence of a previous incident is an example remediation action.

Moving to step 406, one or more computing devices may receive previous paging data. Previous paging data may be maintained in a memory of a computing device and/or as part of a database or other memory location accessible by a computing device. The previous paging data may include data representative of one or more contacts that were identified for mitigating reoccurrence of a corresponding incident of the previous incident data. An entity may maintain historical data of previous paging data, including names and contact information, such as telephone work number, work mobile phone number, personal mobile number, telephone home number, instant messaging data, for individuals that assisted in mitigating the previous incidents. The previous paging data may include other descriptions for the corresponding individuals, including title at the entity, role or position at the entity, daily location schedule, and home and/or office location data. For example, previous paging data may include the name for a service matter expert for the entity that may be responsible for overall operation of a specific system, such as a human resources database. Such previous paging data may include numerous data on the individual in that position. In addition, the previous paging data may include other individuals that work with that individual, including individuals that report to her and who she, the service matter expert, reports to.

In step 408, the ownership data, the previous incident data, and the previous paging data may be compiled as input data to a machine learning model data store. As part of the process of compiling the various data, natural language processing may be utilized in order to account for textual and other data entries that do not consistently identify the same or similar data in the same way. The natural language processing may be utilized to identify text in data of various types and in various formats. The identified text may be grouped with similarly identified text into various fields for inclusion in a machine learning model data store. The machine learning model data store may be configured to maintain the various fields of data. The various fields of data including time series data, scoring data, previous prediction data, and user confirmation data as described herein below. The fields of data maintained in the machine learning model data store may be used thereafter as input data to one or more machine learning models.

Proceeding to step 410, one or more computing devices may receive new incident data representative of a new incident involving one or more of the assets of the entity. The one or more computing devices in step 410 may be one or more of the same computing devices in steps 402-408. New incident data may be maintained in a memory of a computing device and/or as part of a database or other memory location accessible by a computing device. The new incident data may include data representative of an incident of the entity that has occurred where one or more individuals need to be assigned to a conference call or discussion group to mitigate the incident and prevent reoccurrence. Such new incident data may include the impact of the incident on the entity, the specific operation or function of the entity effected, causes of the incident, times of the incident, assets effected, locations of the incident, and the severity of the incident in effecting some operation or function of the entity.

In step 412, paging scheduling data representative of availability of one or more contacts to meet to mitigate the new incident may be received. The one or more computing devices in step 412 may be one or more of the same computing devices in steps 402-410. Paging scheduling data may be maintained in a memory of a computing device and/or as part of a database or other memory location accessible by a computing device. An entity may maintain paging scheduling data, including names and contact information, such as telephone work number, work mobile phone number, personal mobile number, telephone home number, instant messaging data, for individuals that may be identified to assist in mitigating new incidents that occur at the entity. The paging scheduling data may include other descriptions for the corresponding individuals, including title at the entity, role or position at the entity, daily location schedule, and home and/or office location data. For example, paging scheduling data may include the name for a service matter expert for the entity that may be responsible for overall operation of a specific system. Such paging scheduling data may include numerous data on the individual in that position. In addition, the paging scheduling data may include other individuals that work with that individual, including individuals that report to her and who she, the service matter expert, reports to.

In step 414, a first machine learning model may be utilized. The first machine learning model may operate on one or more computing devices, such as the one or more computing devices in steps 402-412. The first machine learning model may be trained to recognize one or more relationships between input data in the machine learning model data store. The first machine learning model may be configured to refine model data that is stored in the machine learning model data store. The refinement data updates the input data in the machine learning model data store based upon the new incident data and paging scheduling data. Proceeding to step 416, the updated input data is received by the machine learning model data store where it is maintained.

In step 418, a second machine learning model may be utilized. The second machine learning model may operate on one or more computing devices, such as the one or more computing devices in steps 402-414. The second machine learning model may be trained to recognize one or more relationships between the input data in the machine learning model data store, the new incident, and the paging scheduling data. In step 420, the second machine learning model may be configured to predict one or more contacts to assign to the new incident to mitigate the incident. The one or more contacts may be individuals in the paging scheduling data that has been inputted and maintained in the machine learning model data store in step 416. The predicted contacts may be those individuals that the second machine learning model has determined to be the individuals that should be on a conference call or part of a discussion group to mitigate the new incident based upon what it has learned from previous incidents and feedback data.

Moving to step 422, a score for each of the one or more predicted contacts to assign to the new incident may be generated. Each score may be representative of a confidence level of the particular contact being an appropriate contact to assign to the new incident. Each score concurrently or alternatively may be representative of a priority level of the particular contact being a contact with a designated priority level or concurrently or alternatively may be representative of a ranking of the particular contact with respect to the other predicted contacts.

In step 424, one or more computing device may predict a severity level of the new incident. A severity level may be some type of designation that the entity has to gauge how impactful such an incident may have on the entity. For example, a cybersecurity breach may be predicted as a high severity level in comparison to a single backup server, among a plurality of backup servers in a pool of servers becoming inoperable. The severity level may be based on the recognized one or more relationships between the input data in the machine learning model data store, the new incident, and the paging scheduling data.

Proceeding to step 426, one or more computing device may assign one or more of the predicted contacts to the new incident. By assigning one or more of the predicted contacts to the new incident, a conference call or discussion group may be arranged between the assigned contacts. Step 426 may include receiving a user input that is representative of a confirmation of assigning, to the new incident, one or more of the predicted contacts. For example, the system may be configured to be completely automated where predicted contacts to assign to a new incident are automatically assigned. In other instances, the system may be configured to require a confirmation by an individual prior to assigning one or more of the predicted contacts to the new incident. Such an individual may receive a listing of the one or more contacts that the system has predicted to be assigned to the new incident. In response, the individual may confirm all, some, or none of the contacts that the system has predicted. In some occurrences, the individual may identify additional and/or different contacts to assign to the new incident. This user confirmation and/or user override of contact assignment may be feedback data to the machine learning model data store. Input data maintained in the machine learning model data store and utilized by the machine learning models described herein may be updated to account for the feedback data. In a future instance, the second machine learning model may learn how a previous prediction of contacts to assign to a new incident was changed and/or confirmed by a user and may apply the same when a similar incident occurs in the future.

In step 428, one or more computing devices, including one or more computing devise as part of a paging system, may send an invitation, to each of the one or more contacts assigned to the new incident, to a conference call, discussion group, or other meeting to mitigate the new incident. An invitation may be sent as a call to an assigned contact to join a conference call, as a text message or email to an assigned contact to join a conference meeting, as an instant message to an assigned contact to join a conference call, and/or other some other type of notification such as an alert banner on a mobile device. Thereafter, the assigned contacts may meet to discuss one or more remediation actions to take in response to the new incident.

One or more steps of the example may be rearranged, omitted, and/or otherwise modified, and/or other steps may be added.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method comprising:
compiling, by a first computing device and by utilizing natural language processing, ownership data, previous incident data, and previous paging data as input data to a machine learning model data store, wherein the ownership data comprises data representative of assets, involved in one or more incidents, of an entity and data representative of associations between the assets, wherein the previous incident data comprises data representative of the one or more incidents that were assigned at least one remediation action, wherein each remediation action was assigned to mitigate reoccurrence of a corresponding incident, and wherein the previous paging data comprises data representative of one or more contacts that were identified for mitigating reoccurrence of a corresponding incident of the previous incident data;
receiving, from a second computing device utilizing a first machine learning model trained to recognize one or more relationships between the input data in the machine learning model data store, refinement data, wherein the refinement data updates the input data in the machine learning model data store based upon new incident data, representative of a new incident involving one or more of the assets, and paging scheduling data, representative of availability of the one or more contacts to meet to mitigate the new incident;
predicting, via a second machine learning model trained to recognize one or more relationships between the input data in the machine learning model data store, the new incident, and the paging scheduling data, one or more contacts to assign to the new incident; and
based upon the predicted one or more contacts, outputting contact data representative of the one or more contacts to assign to the new incident.

2. The method of claim 1, further comprising receiving, by the first computing device, the ownership data.

3. The method of claim 1, further comprising receiving, by the first computing device, the previous incident data.

4. The method of claim 1, further comprising receiving, by the first computing device, the previous paging data.

5. The method of claim 1, further comprising receiving, by the second computing device, the new incident data.

6. The method of claim 1, further comprising receiving, by the second computing device, the paging scheduling data.

7. The method of claim 1, further comprising sending an invitation, to each of the one or more contacts assigned to the new incident, to a meeting to mitigate the new incident.

8. The method of claim 1, wherein the contact data further comprises data identifying why the one or more contacts to assign to the new incident were outputted by the second machine learning model.

9. The method of claim 1, further comprising:
generating, based on the predicted one or more relationships, a score for each of the one or more contacts to assign to the new incident, each score representative of a confidence level of the contact being an appropriate contact to assign to the new incident,
wherein the outputting is based on each of the scores satisfying a threshold.

10. The method of claim 9, wherein the outputting contact data comprises predicting a severity level of the new incident based on the recognized one or more relationships between the input data in the machine learning model data store, the new incident, and the paging scheduling data.

11. The method of claim 1, wherein the first and second computing devices are the same computing device.

12. The method of claim 1, further comprising receiving a user input representative of a confirmation of assigning, to the new incident, one or more of the predicted contacts.

13. The method of claim 1, wherein the compiling further comprises compiling, by the first computing device, user input representative of changes to the one or more contacts to assign to the new incident.

14. A computing device comprising:
one or more processors; and
memory storing instructions that, when executed by the one or more processors, cause the computing device to:
compile, by utilizing natural language processing, ownership data, previous incident data, and previous paging data as input data to a machine learning model data store, wherein the ownership data comprises data representative of assets, involved in one or more incidents, of an entity and data representative of associations between the assets, wherein the previous incident data comprises data representative of the one or more incidents that were assigned at least one remediation action, wherein each remediation action was assigned to mitigate reoccurrence of a corresponding incident, and wherein the previous paging data comprises data representative of one or more contacts that were identified for mitigating reoccurrence of a corresponding incident of the previous incident data;
receive refinement data from a first machine learning model trained to recognize one or more relationships between the input data in the machine learning model data store, wherein the refinement data updates the input data in the machine learning model data store based upon new incident data, representative of a new incident involving one or more of the assets, and paging scheduling data, representative of availability of the one or more contacts to meet to mitigate the new incident;
predict, via a second machine learning model trained to recognize one or more relationships between the input data in the machine learning model data store, the new incident, and the paging scheduling data, one or more contacts to assign to the new incident; and
based upon the predicted one or more contacts, output contact data representative of the one or more contacts to assign to the new incident.

15. The computing device of claim 14, wherein the instructions, when executed by the one or more processors, cause the computing device to send an invitation, to each of the one or more contacts assigned to the new incident, to a meeting to mitigate the new incident.

16. The computing device of claim 14, wherein the instructions, when executed by the one or more processors, cause the computing device to identify why the one or more contacts to assign to the new incident were outputted by the second machine learning model.

17. The computing device of claim 14, wherein the instructions, when executed by the one or more processors, cause the computing device to generate, based on the predicted one or more relationships, a score for each of the one or more contacts to assign to the new incident, each score representative of a confidence level of the contact being an appropriate contact to assign to the new incident, wherein the outputting is based on each of the scores satisfying a threshold.

18. The computing device of claim 14, wherein the instructions, when executed by the one or more processors, cause the computing device to predict a severity level of the new incident based on the recognized one or more relationships between the input data in the machine learning model data store, the new incident, and the paging scheduling data, one or more contacts to assign to the new incident.

19. One or more non-transitory media storing instructions that, when executed by one or more processors, cause the one or more processors to perform steps comprising:
compile, by utilizing natural language processing, ownership data, previous incident data, and previous paging data as input data to a machine learning model data store, wherein the ownership data comprises data representative of assets, involved in one or more incidents, of an entity and data representative of associations between the assets, wherein the previous incident data comprises data representative of the one or more incidents that were assigned at least one remediation action, wherein each remediation action was assigned to mitigate reoccurrence of a corresponding incident, and wherein the previous paging data comprises data representative of one or more contacts that were identified for mitigating reoccurrence of a corresponding incident of the previous incident data;
receive refinement data by a first machine learning model trained to recognize one or more relationships between the input data in the machine learning model data store, wherein the refinement data updates the input data in the machine learning model data store based upon new incident data, representative of a new incident involving one or more of the assets, and paging scheduling data, representative of availability of the one or more contacts to meet to mitigate the new incident;
predict, via a second machine learning model trained to recognize one or more relationships between the input data in the machine learning model data store, the new incident, and the paging scheduling data, one or more contacts to assign to the new incident; and
based upon the predicted one or more contacts, output contact data representative of the one or more contacts to assign to the new incident.

20. The one or more non-transitory media storing instructions of claim 19 that, when executed by the one or more processors, cause the one or more processors to perform a further step comprising send an invitation, to each of the one or more contacts assigned to the new incident, to a meeting to mitigate the new incident.
